(19) United States
(12) Patent Application Publication
(10) Pub. No.: US 2008/0274803 A1
(43) Pub. Date: Nov. 6, 2008

(54) System for Processing Data in a Community, and Methods Thereof

(75) Inventor: Zoo Il Yang, Gyeonggi-do (KR)

Correspondence Address: HUSCH BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 10/599,157

(22) PCT Filed: Mar. 21, 2005
(86) PCT No.: PCT/KR05/00810

§ 371 Date: Sep. 21, 2006

(30) Foreign Application Priority Data
Mar. 26, 2004 (KR) 10-2004-0020744

(51) Int. Cl. G06F 17/00

(52) U.S. Cl. 463/29; 463/42

(57) ABSTRACT

Disclosed is a system and method for processing data in a community such as a café, homepage, blog, mini-room, mini-homepage, and the like, which are established in web sites on the Internet. The method for processing data in a community established on a website includes a) by a community visitor, accessing the community and selecting a link program prepared in the community, b) confirming whether the community visitor executes or terminates the link program, c) receiving visitor-related data related to the execution of the link program when the link program is terminated, d) processing and utilizing the visitor-related data in the community, and e) storing the processed visitor-related data in the community. According to the present invention, it is possible to please community visitors through interaction with the visitors in the community. In addition, enjoyment factors can be amplified by providing historical information and event factors caused by game action. Further, the degree of participation of the visitors in the community becomes more increased and re-visit of the visitors to the community can be promoted.

### TECHNICAL FIELD

The present invention relates to a system and method for processing data in a community, and more particularly, to a system and method for processing data in a community, such as a café, homepage, blog, mini-room, mini-homepage, and the like, which are established in web sites on the Internet.

### BACKGROUND ART

At present, there exist various websites providing Internet community services. In these Internet community sites, a community operator can establish a community by applying for the community to a relevant Internet Service Provider, and users can become members of the community by subscribing to that community. The community operator and members compose one community.

In current Internet community services, one community continues to exist, in principle, as an individual, which is separate from other communities. Optionally, it could be designed to allow communities to share information according to operation methods of the Internet Service Providers.

On the other hand, in the current Internet community services, horizontal movement from one community to another community is possible, and each of the Internet communities which are presently running includes one or more public or private bulletin boards.

Also, in the case of a variety of online games with several millions of users and with several hundreds of thousands of simultaneous connecting users, a plurality of small and medium communities called ‘clans’ or ‘guilds’ are organized. These communities are composed of users who enjoy the same games. These users often do energetic activities online or offline, such as studies and discussions on various game tactics, play of games in combination for missions, and the like.

FIG. 1 is a schematic diagram illustrating configuration of a conventional community on an Internet network.

Referring to FIG. 1, the conventional community can be implemented with a plurality of websites 120,130, and 140 and an individual community 150, and the like, all of which are connected through the Internet 110. The plurality of websites 120, 130, and 140 include first to N-th communities respectively, for example, the second website 130 includes communities 131, 132, and 133. In this case, each of the first to N-th communities 131, 132, and 133 may include a blog 161, a mini-room 162, a mini-homepage 163, and the like.

FIG. 2 is a diagram illustrating an example of a conventional website having a community and a contents server. A conventional website 210 can include a community 211 accessed by a plurality of clients 221, 222, and 223 and a contents server 212 providing a plurality of contents to the community 211.

Referring to FIG. 2, in the conventional website 210 having the community and the contents server, when the plurality of clients 221, 222, and 223 access the community 211 and then select a link program in the community 211, they are connected to a website 230 actually having the link program. The website 230 manages game scores made by the plurality of clients 221, 222, and 223, for example, when the plurality of clients 221, 222, and 223 execute a game program. Also, if the link program is provided from the contents server 212 on a web browser of the community 211, the website 210 having the contents server 212 manages data related to the plurality of clients 221, 222, and 223. In other words, the community 211 only plays a role of connection of the link program, and substantial execution of the link program and management of the data are performed by the websites providing the link program.

On the other hand, the blog, which is an abbreviation of web log, refers to a new form of web service having complex functions of a web bulletin board, individual homepages, and communities. Typically, a blog service is a service provided to solve problems such as anonymity, unidirectionality, low contents notice rate, and the like, which are disadvantages of conventional Internet bulletin boards. It means a kind of individual media community having an exclusive area assigned on a network by using a simple text or graphic way. That is, since the blog service can obtain the effect of security and confidentiality of an individual homepage while providing service subscribers with a simple creation technique that does not require knowledge related to use of an existing homepage creation program and Internet homepage creation, the range of users has been rapidly expanded.

More particularly, it is known that John Barger first used the term ‘web log’ in November of 1997, and the term ‘log’ has a meaning of logbook or travel diary. In a blogger that is a site for blogging, which was invented by Evan Williams, the blog is defined as “web page consisting of short sentences which are updated periodically, like a diary”. Thus, anyone can set such a blog in his own web site and download and use a blog program without fee as long as the blog has a server space in which the blog program can be installed. Also, the blog is free of charge and is easy to handle, and, once it is set on a website, a user can always publish his sentences on-line whenever he wishes to write the sentences.

Up to now, netizens have used individual homepages to let their existences or opinions be known on-line. To this end, however, they had to be able to handle webpage creation tools, such as Namo WebEditor, and the like, and may also have had many difficulties in management, such as updating, and the like, of their individual homepages. On the contrary, as mentioned above, the blog is free of charge and is easy to handle, and, once it is set on a website, a user can easily enter his sentences online, allowing anyone to make an easy access to the blog.

Recently, a portal site, Naver, (www.naver.com), has started providing a service, ‘cafeiN’, and Naver café now has three hundred thousand associations of like-minded persons, and two thousand associations of like-minded persons are being newly established on average per day. The portal site, Naver, interlinks two services, that is, a service allowing a visitor to leave a sentence in a café and another service allowing the sentence and its source to be noticed in the visitor's blog.

On the other hand, in a community, for example, a blog that is an individual community, a host desires to please visitors and feels an enjoyment and satisfaction by visitor's feedback. In this connection, conventional blogs have problems in that items attracting strangers' visits and causing enjoyment are standardized, interaction between communities is restricted, and moreover, the blogs are plain since the first consideration is given to texts.

### DISCLOSURE

### Technical Problem

As mentioned above, in a community, for example, a blog that is an individual community, a host desires to please visitors and feels an enjoyment and satisfaction by visitor's feedback, however, conventional blogs have problems in that items attracting strangers' visits and causing enjoyment are standardized, interaction between communities is restricted, and moreover, the blogs are plain since the first consideration is given to texts.

### Technical Solution

In order to solve the above-mentioned problems, it is an object of the present invention to provide a system and method for processing data in a community that is capable of attracting the participation of a large number of visitors in the community by providing dynamic community participation contents.

It is another object of the present invention to provide a system and method for processing data in a community in which contents are easily distributed by being basically loaded on a web browser without a separate installation process.

It is yet another object of the present invention to provide a system and method for processing data in a game-linked blog that is capable of providing services specialized by blog items and creating customized services.

To achieve the above objects, one aspect of the present invention provides a method for processing data in a community established on a website, the method comprising a) by a community visitor, accessing the community and selecting a link program prepared in the community, b) confirming whether the community visitor executes or terminates the link program, c) receiving visitor-related data related to the execution of the link program when the link program is terminated, and d) processing and utilizing the visitor-related data in the community.

Preferably, the method further includes e) storing the processed visitor-related data in the community.

Preferably, the community comprises a café, a homepage, a blog, a mini-room, or a mini-homepage, which are established in web sites on the Internet.

Preferably, the link program is a program connected to other websites or a program connected to a contents server of the website to which the community belongs.

Preferably, the link program is a game program.

Preferably, the visitor-related data are game or community use data and are at least one selected from a group consisting of item, level, score, and rank data obtained when the link program is executed and used.

Preferably, the stored visitor-related data are updated whenever the community visitor executes and uses the link program.

Preferably, the community visitor acquires events for the execution of the link program.

According to another aspect, the present invention provides a method for processing data in a community established on a website, the method comprising a) by a community visitor, accessing the community and selecting a link program prepared in the community, b) receiving visitor-related data related to execution of the link program, c) processing and utilizing the visitor-related data in the community, and d) storing the processed visitor-related data in the community.

Preferably, the link program is a program connected to a contents server of the website to which the community belongs or a program connected to other websites, and the contents server causes the link program to be executed on a web browser of the community.

According to yet another aspect, the present invention provides a system for processing data in a community established on a website, the system comprising a connector for determining whether or not a community visitor is permitted to access the community, a controller for causing the community visitor with permission to access the community to select a link program prepared in the community and receiving visitor-related data from a website providing the link program, a data processor for processing the visitor-related data such that the visitor-related data are utilized in the community, and a data storage for storing the processed visitor-related data.

Preferably, the controller keeps a resource occupation ratio of a system operated by the community at an appropriate level such that the resource occupation ratio does not exceed a prescribed rate.

According to yet another aspect, the present invention provides a method for processing game-linked data in a community established on a website, the method comprising a) by a community visitor, accessing the community and selecting a game program prepared in the community, b) confirming whether the community visitor executes or terminates the game program, c) receiving game data of the visitor obtained in connection with the execution of the game program when the game program is terminated, d) processing the game data of the visitor as ranking data in the community, and e) storing the processed ranking data in the community.

### ADVANTAGEOUS EFFECTS

According to the present invention, it is possible to please community visitors through interaction with the visitors in the community. In addition, enjoyment factors can be amplified by providing historical information and event factors caused by game action. Further, the degree of participation of the visitors in the community becomes more increased and re-visit of the visitors to the community can be promoted.

### DESCRIPTION OF DRAWINGS

FIG. 1 is a schematic diagram illustrating configuration of a conventional community on an Internet network.

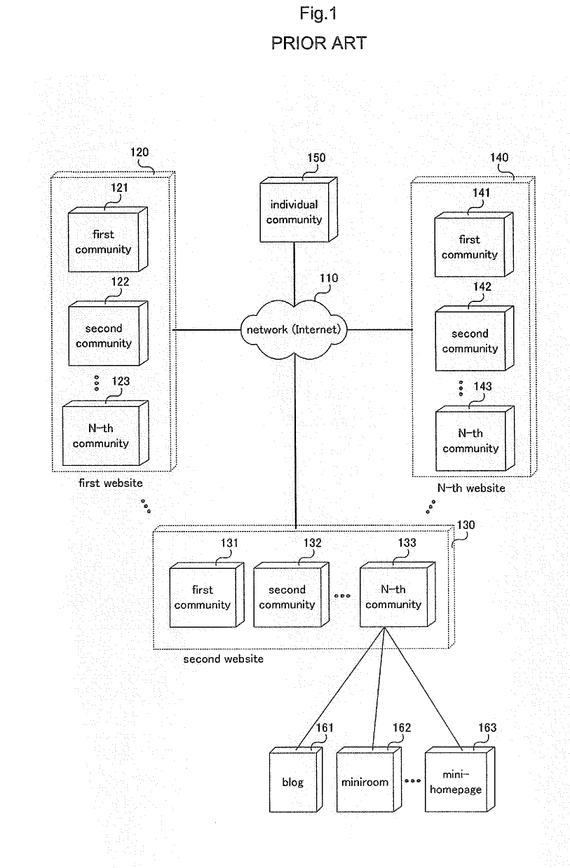

FIG. 2 is a diagram illustrating an example of a conventional website having a community and a contents server.

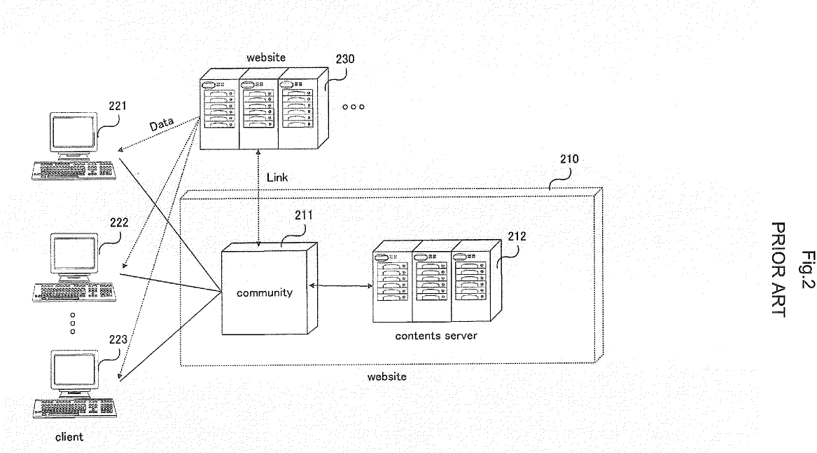

FIG. 3 is a diagram illustrating a method of processing data in a community according to an embodiment of the present invention.

FIG. 4 is a schematic diagram illustrating configuration of a data processing system in a community according to an embodiment of the present invention.

FIG. 5 is a flow chart illustrating a data processing method in a community according to an embodiment of the present invention.

FIG. 6 is a flowchart illustrating a data processing method in a community according to another embodiment of the present invention.

FIG. 7 is a diagram illustrating a game ranking data processing method in a flash game-linked blog according to a concrete embodiment of the present invention.

FIG. 8 is a flow chart illustrating a game ranking data processing method in a flash game-linked blog according to a concrete embodiment of the present invention.

FIG. 9 is a diagram illustrating an example of a game ranking data process in a flash game-linked blog according to a concrete embodiment of the present invention.

### MODE FOR INVENTION

Hereinafter, a system and method for processing data in a community according to exemplary embodiments of the present invention will be described in detail with reference to the accompanying drawings.

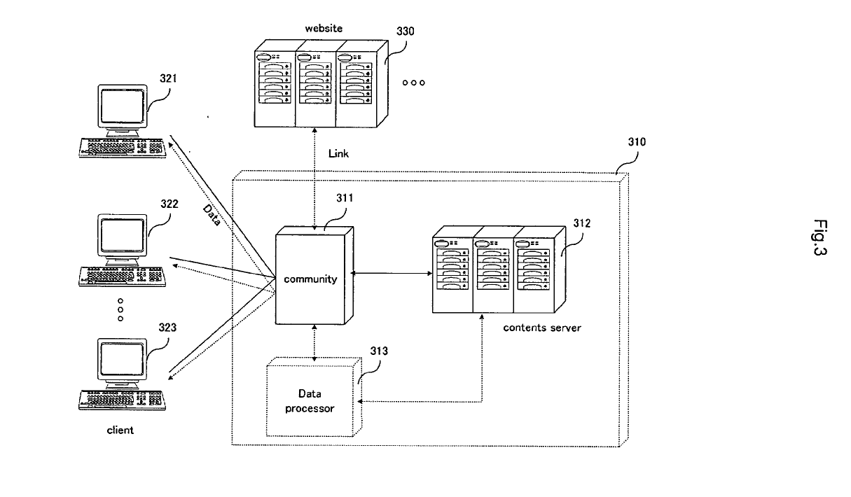

FIG. 3 is a diagram illustrating a method of processing data in a community according to an embodiment of the present invention.

As shown in FIG. 3, a website 310 includes a community 311, to which a plurality of clients 321, 322, and 323 are connected, and a contents server 312 providing a plurality of contents to the community 311. Here, the community 311 is further connected to a data processor 313 that can be implemented by a software program.

More specifically, when the plurality of clients 321, 322, and 323 access the community 311 and then execute a link program, the community 311 receives information on history or rank of the plurality of clients 321, 322, and 323, which is related to the link program, from a website 330 or the contents server 312 providing the link program and uses the information processed in a desired form of data by the data processor 313.

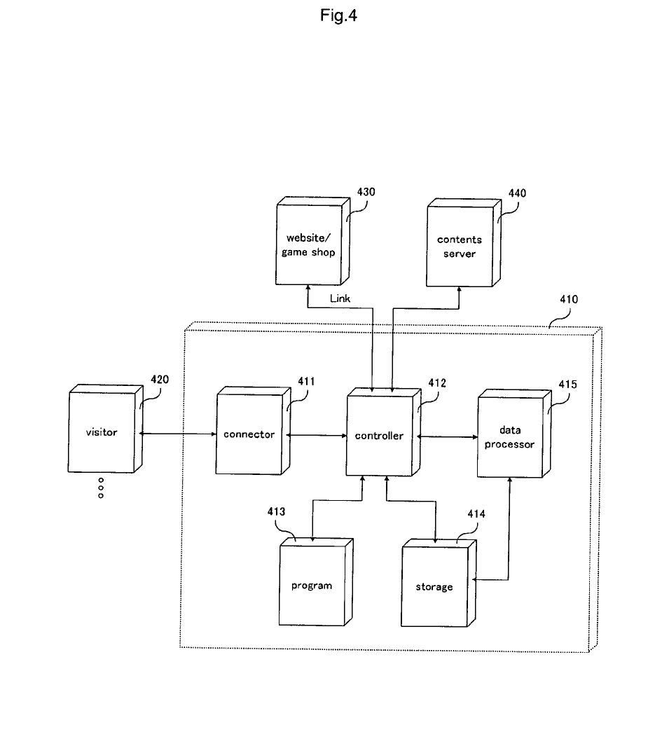

FIG. 4 is a schematic diagram illustrating configuration of a data processing system in a community according to an embodiment of the present invention.

Referring to FIG. 4, a data processing system 410 in a community according to an embodiment of the present invention includes a connector 411, a controller 412, an application program 413, a data storage 414, and a data processor 415.

The connector 411 determines whether or not a visitor 420 is permitted to access the community. For example, the connector 411 may perform procedures related to subscription and authentication of the visitor 420 according to operation methods of the community. In this case, the visitor 420 may be a plurality of clients and the community may be cafés, homepages, blogs, mini-rooms, or mini-homepages that are established in websites on the Internet.

The controller 412 causes the visitor 420 who accessed the community to select one of the link programs prepared in the community, and then, receives visitor-related data from a website 430 providing the link program. In this case, it is preferable that the controller 412 keeps a resource occupation ratio of a system operated by the community at an appropriate level such that the resource occupation ratio does not exceed a prescribed rate.

In this case, the link program may be a program connected to a contents server of a website to which the community belongs, or a program connected to another website, and the contents server can allow the link program to be executed on a web browser of the community.

The data processor 415 processes the visitor-related data such that the data can be utilized in the community, and the data storage 414 stores the processed visitor-related data. The processed visitor-related data can be updated whenever the link program is executed. In addition, the application program 413 may be a bulletin board, an editor, a visitor's book, and the like, which are required to operate the community.

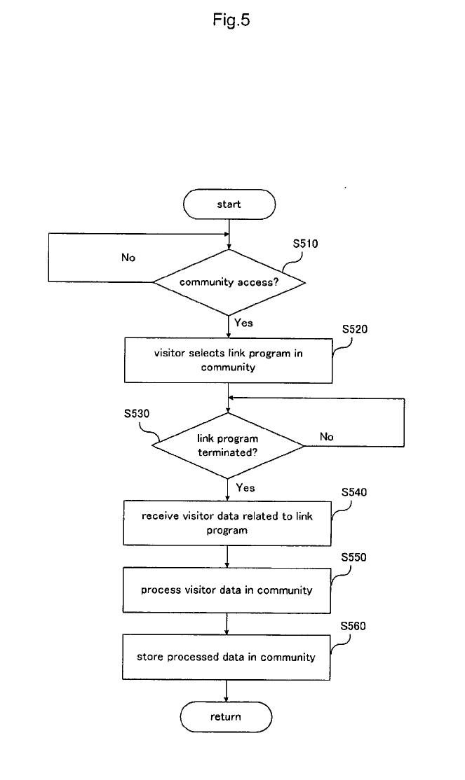

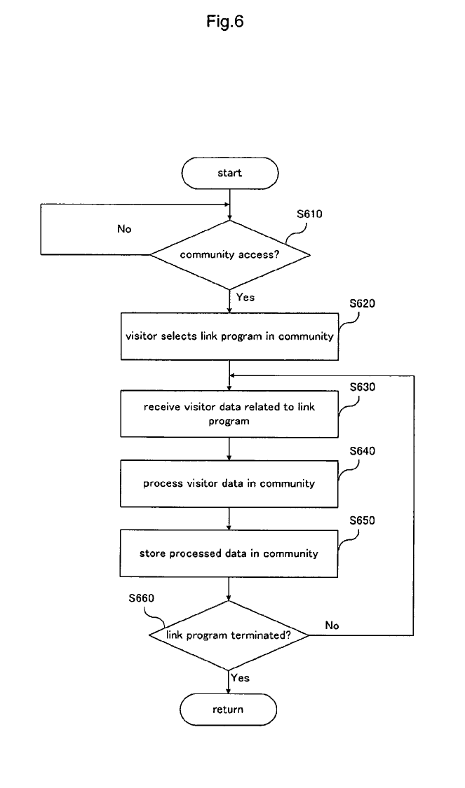

Hereinafter, the data processing method in the community according to an embodiment of the present invention will be described in detail with reference to FIGS. 5 and 6.

FIG. 5 is a flow chart illustrating the data processing method in the community according to an embodiment of the present invention.

Referring to FIG. 5, in the data processing method in the community according to an embodiment of the present invention, first, a visitor accesses the community that is a café, homepage, blog, mini-room, or mini-homepage established in a website on the Internet (Step S510), and then selects one of the link programs prepared in the community (Step S520). Here, the link program may be a program connected to another website or may be a program connected to a contents server of a website to which the community belongs.

In this case, the link program may be a game program, preferably, a flash game program that is a game item in which users can join simply on a website and from which the users can gain amusement and pleasure. In other words, since a game machine in the community is supported for the purpose of formation of a sense of intimacy between individuals, visitors can understand rules of the game intuitively and join in the game.

Thereafter, it is confirmed whether or not the community visitor executes or terminates the link program (Step S530).

Next, if the community visitor terminates the link program, the community receives the visitor-related data related to the execution of the link program (Step S540), and then processes the received visitor-related data (Step S550). Here, the visitor-related data may be game data, community use data, or data on an event, level, score, or rank obtained when the link program is executed and used. At this time, the visitor-related data may be provided in the form of a webpage at the time of terminating the link program.

Here, the processing of data by the data processor 415 is substantially the same as that of data in other websites providing the link program except that the data are directly processed in the data processing system provided in the community in this embodiment of the present invention. Since technical implementation of such a difference is apparent to those skilled in the art, detailed explanation thereof will be omitted for the purpose of simplicity of description. For example, if the game program is a game program and the other websites are game sites, the data may be ranking data, and the ranking data can be processed in the data processing system according to this embodiment of the present invention instead of the game sites. Of course, the data may be community use data as well as game data, and it is obvious that the data may be data on an event, level, score, or rank obtained when the link program is executed and used.

In addition, the community visitor can acquire events if he achieves a specific result when executing the above link program. For example, after the community visitor accesses the community and executes and uses the link program, events, such as drawing of persons who have large width in the renewal of records, drawing of persons who win first place during a certain period of time, hitting of a specific score, and the like, may be offered to the community visitor.

Thereafter, the processed visitor-related data are stored in the community (Step S560), and the stored visitor-related data can be updated whenever the community visitor executes and uses the link program.

FIG. 6 is a flow chart illustrating a data processing method in a community according to another embodiment of the present invention.

Referring to FIG. 6, in a data processing method in a community according to another embodiment of the present invention, a visitor accesses a community (Step S510) and then selects a link program prepared in the community (Step S620). Here, the community may be a café, homepage, blog, mini-room, or mini-homepage established in a website on the Internet. Also, the link program can be a program connected to a contents server of a website to which the community belongs or a program connected to other websites.

Thereafter, the community receives the visitor-related data related to the execution of the link program (Step S630), and then processes the received data (Step S640). At this time, the visitor-related data may be provided in the form of a data socket at the time of terminating the link program.

Thereafter, the processed visitor-related data are stored in the community (Step S650).

Next, it is confirmed whether or not the community visitor terminates the link program (Step S660), and then, if the community visitor does not terminate the link program, Steps S620 to S640 are repeated.

The data processing method in the community illustrated in FIG. 6 is different from the data processing method illustrated in FIG. 5 in that the visitor-related data are received and processed irrespective of whether or not the link program is terminated. For example, in FIG. 5, in the case that the link program is a game program, if the desired data are ranking data, the desired data can be received only after the link program is substantially terminated. In other words, the data processing method in the community illustrated in FIG. 5 shows that the visitor-related data are received at the time of terminating the link program, and, on the contrary, the data processing method in the community illustrated in FIG. 6 shows that the visitor-related data can be received as they occur, irrespective of whether or not the link program is terminated.

Accordingly, the data processing method can be varied according to forms of visitor-related data desired by the community, the amount of data storage space in the community, or performance of a system operated by the community.

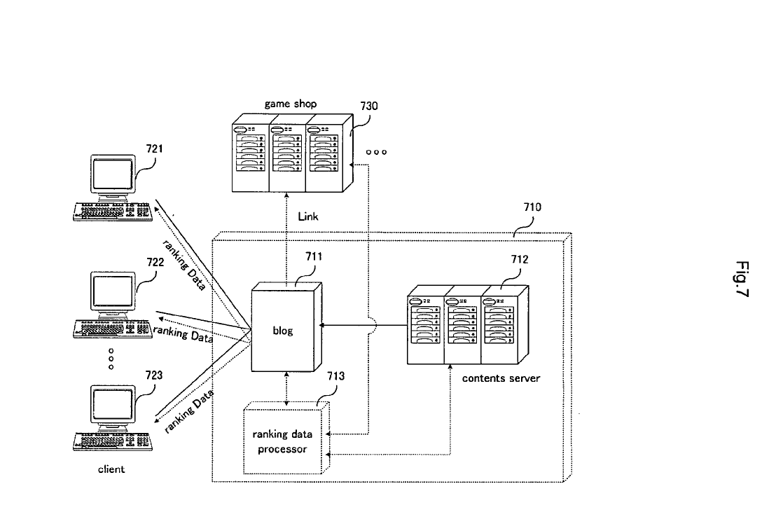

FIG. 7 is a diagram illustrating a game ranking data processing method in a flash game-linked blog according to a concrete embodiment of the present invention, where a data processing method is illustrated in the case that the community is a blog 711.

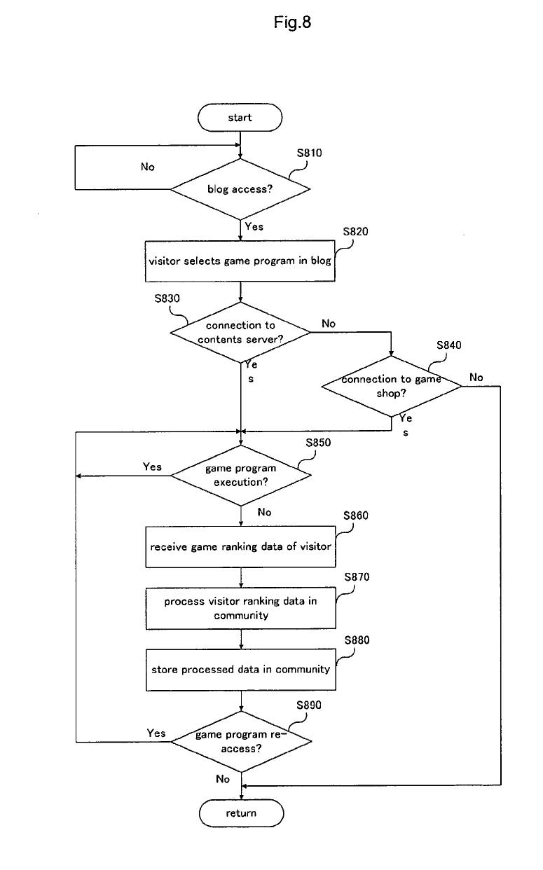

In comparison of the method of FIG. 7 with that of FIG. 3, it can be seen in FIG. 7 that the data processor 313 of FIG. 3 is embodied as a ranking data processor 713 and the website 330 of FIG. 3 is embodied as a game shop 730. Now, the game ranking data processing method in the flash game-linked blog will be described with reference to FIG. 8.

FIG. 8 is a flow chart illustrating the game ranking data processing method in the flash game-linked blog according to the concrete embodiment of the present invention.

Referring to FIG. 8, in the game ranking data processing method in the flash game-linked blog according to the concrete embodiment of the present invention, first, a visitor accesses a community, for example, a blog (Step S810), and then selects a flash game program prepared in the blog (Step S820). In other words, a game is used as post contents giving an amusement element to the visitor, and, for example, a multimedia connection can be utilized in a way that a use link is connected or copied.

Next, if the blog visitor is connected to a contents server in a website to which the blog belongs (Step S830) or connected to the game shop (Step S840), it is confirmed whether or not the flash game program is executed (Step S850).

Next, when the execution of the flash game program is terminated, the game data of the visitor obtained in the execution of the flash game program are received (Step S860), and then processed as ranking data in the community according to the game data of the visitor (Step S870).

Thereafter, the processed ranking data are stored in the community (Step S880), and then, after it is confirmed whether or not the visitor re-accesses the ranking game program (Step S890), the ranking data are updated if the visitor re-uses the flash game program.

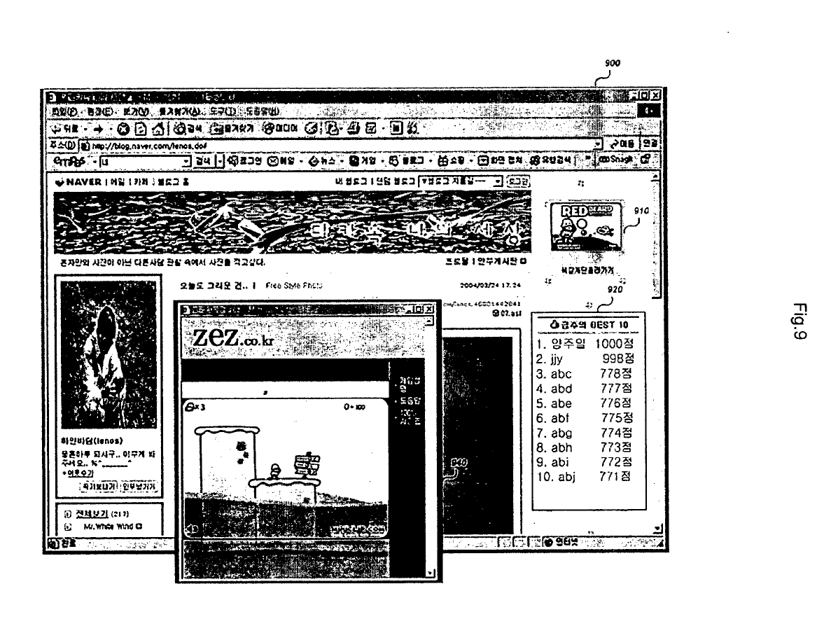

FIG. 9 is a diagram illustrating an example of the game ranking data process in the flash game-linked blog according to the concrete embodiment of the present invention, where a blog screen including a flash game program 910 is shown in the right upper portion of a blog 900 implemented in a website on the Internet. In this blog 900, the best 10 of this week is shown as ranking data. In this figure, reference numeral 940 shows that the flash game program 910 is being executed.

Pleasure through interaction with strangers in this blog is a basic desire, and, as this desire is more satisfied by the present invention, the degree of loyalty and participation for the service becomes more increased. Thus, networks in the blog can be expanded.

Although the exemplary embodiments of the present invention have been described in detail, it is obvious to those skilled in the art that the present invention is not restricted to these embodiments but may be modified or changed in various forms without deviating from the spirit and scope of the invention as set forth in the annexed claims.

### INDUSTRIAL APPLICABILITY

According to the present invention, community participation contents utilized as dynamic contents can attract the participation of a large number of users.

Also, new contents that are easy to be distributed by being basically loaded on a web browser can be provided.

Further, pleasure through interaction with strangers in this blog is a basic desire, and, as this desire is more satisfied, the degree of loyalty and participation for the service becomes more increased. Thus, networks in the blog can be expanded.

1. A method for processing data in a community established on a website, the method comprising:
a) receiving a signal from a user who accesses the community and selects a link provided by the community, wherein the link connects the user to a link program;
b) confirming whether the user executes or terminates the link program;
c) receiving visitor-related data related to the execution of the link program when the link program is terminated; and
d) processing and utilizing the visitor-related data in the community.

2. The method of claim 1, further comprising:
e) storing the processed visitor-related data in the community.

3. The method of claim 1, wherein the community comprises a café, homepage, blog, mini-room, or mini-homepage, which are established in web sites on the Internet.

4. The method of claim 1, wherein the link program is a program stored in other websites and linked from the website which provides the user with the community user interface.

5. The method of claim 1, wherein the link program is a program stored in connected to a contents server of the website to which the community belongs and linked from the website which provides the user with the community user interface.

6. The method of claim 4, wherein the link program is a game program.

7. The method of claim 6, wherein the visitor-related data are game or community use data.

8. The method of claim 1, wherein the visitor-related data are at least one selected from a group consisting of item, level, score, and rank data obtained when the link program is executed and used.

9. The method of claim 1, wherein the stored visitor-related data are updated whenever the community visitor executes and uses the link program.

10. The method of claim 1, wherein the user acquires events for the execution of the link program.

11. A method for processing data in a community established on a website, the method comprising:
a) by a community visitor, accessing the community and selecting a link program prepared in the community;
b) receiving visitor-related data related to execution of the link program;
c) processing and utilizing the visitor-related data in the community; and
d) storing the processed visitor-related data in the community.

12. The method of claim 11, wherein the community comprises a café, homepage, blog, mini-room, or mini-homepage, which are established in web sites on the Internet.

13. The method of claim 11, wherein the link program is a program connected to a contents server of the website to which the community belongs or a program connected to other websites.

14. The method of claim 13, wherein the contents server causes the link program to be executed on a web browser of the community.

15. The method of claim 13, wherein the link program is a flash game program.

16. A system for processing data in a community established on a website, comprising:
a connector for determining whether a community visitor is permitted to access the community;
a controller, the controller allowing the community visitor to access the community to select a link to a link program, provided by the community, the controller receiving visitor-related data from a component providing the link program;
a data processor for processing the visitor-related data such that the visitor-related data are utilized in the community; and
a data storage for storing the processed visitor-related data.

17. The system of claim 16, wherein the controller keeps a resource occupation ratio of a system operated by the community at an appropriate level such that the resource occupation ratio does not exceed a prescribed rate.

18. The system of claim 16, wherein the link program is a program stored in a contents server of the website to which the community belongs or a program stored in other websites than the website to which the community belongs.

19. The system of claim 16, wherein the contents server causes the link program to be executed on a web browser of the community.

20. The system of claim 16, wherein the community comprises a café, homepage, blog, mini-room, or mini-homepage, which are established in web sites on the Internet.

21. A method for processing game-linked data in a community established on a website, the method comprising:
a) by a community visitor, accessing the community and selecting a game program prepared in the community;
b) confirming whether the community visitor executes or terminates the game program;
c) receiving game data of the visitor obtained in connection with the execution of the game program when the game program is terminated;
d) processing the game data of the visitor as ranking data in the community; and.
e) storing the processed ranking data in the community.

22. A method for processing game-linked data in a community established on a website, the method comprising:
a) by a community visitor, accessing the community and selecting a game program prepared in the community;
b) confirming whether the community visitor executes or terminates the game program;
c) receiving game data of the visitor obtained in connection with the execution of the game program when the game program is terminated;
d) processing the game data of the visitor as ranking data in the community;
e) storing the processed ranking data in the community; and
f) updating the ranking data by repeating the steps b) to d) whenever the visitor executes and uses the game program.

23. The method of claim 5, wherein the link program is a game program.

24. The method of claim 23, wherein the visitor-related data are game or community use data.
